(19) United States
(12) Patent Application Publication
(10) Pub. No.: US 2016/0316306 A1
(43) Pub. Date: Oct. 27, 2016

(54) MONITORING ACOUSTIC ENERGY OF HEADSET

(71) Applicant: ElaraTek Ltd., Leeds (GB)

(72) Inventors: Amir NOORALAHIYAN, Leeds (GB); Bahador PAKBAZ, Tehran (IR)

(21) Appl. No.: 15/099,683

(22) Filed: Apr. 15, 2016

(30) Foreign Application Priority Data
Apr. 22, 2015 (GB) 1506823.2

(51) Int. Cl. H04R 29/00; G06F 3/16

(52) U.S. Cl. CPC H04R 29/001; G06F 3/162; H04R 29/008; H04R 2430/01

(57) ABSTRACT

For monitoring acoustic energy experienced by a user of a headset (20, 25), a processor (30) and a user interface (90) are provided, the processor having a monitoring part (40) to obtain an accumulated acoustic energy already experienced, to determine (60) a remaining allowable acoustic energy up to a maximum allowable daily threshold. A predicted remaining listening time is determined (70) based on an actual rate of acoustic energy, and on the remaining allowable acoustic energy, and is output visually or acoustically using the user interface. This helps enable the user to control their exposure with or without prior user input of an expected period of listening time. It can be updated after a change in volume control by the user. A gain control mode involves controlling the gain to cause the accumulated acoustic energy to reach the maximum allowable daily threshold at the end of a user defined period.

### TECHNICAL FIELD

The present invention relates to apparatus for monitoring acoustic energy, to headsets or computing devices having such apparatus and to corresponding methods and computer programs.

### BACKGROUND

It is known to provide apparatus for monitoring exposure of a user of a headset to the acoustic energy produced by the headset. In U.S. Pat. No. 6,826,515 it is explained that the acoustic energy (such as accumulated amount of noise, or dose in terms of an average noise level, and the maximum level of noise to which an individual has been exposed during a workday) is important to occupational safety and health of the user. Regulatory agencies may require accurate acoustic energy data or measurements. Examples of such noise data measurements include impulse noise, continuous noise, and an eight-hour time-weighted average (“TWA”). Impulse noise relates to noise of very short duration, less than a few thousandths of a second, which also repeats less than once a second. Continuous noise relates to noise that is longer in duration than impulse noise, extending over seconds, minutes, or hours. Eight-hour TWA relates to the average of all levels of impulse and continuous noise to which the user is exposed during an eight-hour workday. A maximum threshold for level for impulse noise in some countries is 140 dBSPL measured with a fast peak-hold sound level meter (“dBSPL” stands for sound pressure level, or a magnitude of pressure disturbance in air, measured in decibels). A maximum threshold level for continuous noise in some countries is 115 dBA (read on the slow average “A” scale). A daily maximum threshold may be expressed as the eight-hour TWA and may be 85 dBA.

Measuring the exposure to acoustic energy related to headsets such as telephone headsets or recreational music headsets is especially important.

Headsets generate their sound levels at or in the user's ear canal rather than external to the user. Some individuals may listen to music at levels much higher than the voice signals of typical telephone systems. As such, a headset user is exposed to varying levels of sound pressure over varying lengths of time with no capability of assuring real-time compliance with exposure limits set by regulations or health guidance.

In U.S. Pat. No. 6,826,515 monitoring audio dosage from a headset includes sampling an input sound signal, calculating a headset sound level based on the input sound signal samples, and calculating the cumulative exposure of the headset user to the headset sound level at a specific point in time. These calculations are repeated to update the measure of the user's accumulated exposure to sound during the time that the user is wearing the headset. An exposure extrapolation can determine what the final free field exposure level will be over the specified durational time period (typically 8 hours) if no changes are made to the system gain. A user interface allows the user to enter calculation parameters such as threshold levels, weighting factors, durational time, and the type of headset, and allows for gain adjustments by the headset user. The user interface may include input interfaces such as a keyboard or mouse and an output such as a display.

### SUMMARY

Embodiments of the invention provide improved methods and apparatus.

According to a first aspect of the invention, there is provided apparatus for monitoring acoustic energy experienced by a user of a headset, the apparatus having a processor and a user interface, the processor being configured, in a gain control mode, to obtain an accumulated acoustic energy already experienced by the user after a start time, receive a user input indicating a desired period of listening to reach a maximum allowable threshold of accumulated acoustic energy, and control a gain to increase a volume level of the headset to cause the accumulated acoustic energy to reach a maximum allowable threshold at the end of the desired period. This can provide better maximization of available acoustic energy allowance than conventional controllers which only limit the gain to ensure compliance without increasing the volume to exploit any remaining headroom below the allowable threshold. Any additional features can be added to or disclaimed from this aspect, and some such additional features are described and claimed below. An additional feature is a passive display mode, in which the processor is configured to:

obtain an accumulated acoustic energy already experienced by the user after a start time, and determine a remaining allowable acoustic energy by comparing the accumulated acoustic energy to a maximum allowable threshold. It is also configured to determine a predicted remaining listening time based on an actual rate of acoustic energy, and on the remaining allowable acoustic energy, and

cause the user interface to output an indication of the predicted remaining listening time to the user. Compared to a conventional output indicating a projected energy exposure by the end of a preselected period, the predicted remaining listening time is more useful, easier to understand and helps enable a listener to control their exposure with or without prior user input of an expected period of listening time, and therefore allows the user to protect his or her hearing against prolonged exposure to high levels of acoustic energy.

One such additional feature is the processor being configured to receive an indication of a change in volume control by the user, to update the actual rate of acoustic energy since the change in volume control, and to update the predicted remaining listening time according to the updated actual rate of acoustic energy.

For the gain control mode in which the processor is configured to respond to a user input indicating a desired period of listening to reach the threshold, by controlling a gain of the output of the headset, to cause the accumulated acoustic energy to reach the maximum allowable threshold at the end of the desired period, another such additional feature is the processor being configured to determine a desired rate of acoustic energy suitable to cause the accumulated acoustic energy to reach the maximum allowable threshold at the end of the desired period, and to control the gain based on that desired rate of acoustic energy, and based on the actual rate of acoustic energy. Another such additional feature is the processor being configured to update the desired rate of acoustic energy during the desired period. Another such additional feature is the processor being configured to update the actual rate of acoustic energy during the desired period of listening. Another such additional feature is the processor being configured to respond to a volume control input by the user by at least one of: making a gradual change in gain over a period of time to compensate for the volume control input, maintaining the same gain control mode without compensating, and ceasing the gain control mode.

Another such additional feature is the processor being configured to receive a user input indicating a pause in the desired period of listening, and to respond by at least one of: adapting the desired rate of acoustic energy to compensate for the pause, and increasing the desired period to compensate for the pause.

Another such additional feature is the user interface having a display and the indication of predicted remaining listening time comprising at least one of: a visual indication on the display of the predicted remaining listening time, an acoustic indication of the predicted remaining listening time, an indication of the accumulated acoustic energy, an indication of what proportion of the desired listening time is remaining, and an indication of what proportion of the allowable threshold is the accumulated acoustic energy.

Another aspect provides a headset comprising the apparatus for monitoring as set out above. Another aspect provides a computing device comprising the apparatus for monitoring as set out above and having an audio circuit for generating an audio signal for the headset, and a display for the output to the user. Such a computing device can be for example a mobile device or personal computer or system comprising a remote server coupled to a local device having a user interface. Another aspect provides a method of monitoring acoustic energy experienced by a user of an acoustic headset, having, in a gain control mode, steps of: obtaining an accumulated acoustic energy already experienced by the user after a start time, receiving a user input indicating a desired period of listening to reach a maximum allowable threshold of accumulated acoustic energy, and controlling a gain to increase a volume level of the headset to cause the accumulated acoustic energy to reach a maximum allowable threshold at the end of the desired period. Another feature is a passive display mode having steps of obtaining an accumulated acoustic energy already experienced by the user after a start time, determining a remaining allowable acoustic energy by comparing the accumulated acoustic energy to a maximum allowable threshold, determining a predicted remaining listening time based on an actual rate of acoustic energy, and on the remaining allowable acoustic energy, and outputting to the user an indication of the predicted remaining listening time.

Another such additional feature is having steps of receiving an indication of a change in volume control of the headset by the user, updating the actual rate of acoustic energy since the change in volume control, and updating the predicted remaining listening time according to the updated actual rate of acoustic energy.

Another such additional feature for the gain control mode of operation in which a user input indicates a desired period of listening with a maximised rate of accumulation, and the gain is controlled to cause the accumulated acoustic energy to reach the maximum allowable threshold at the end of the desired period, is a step of determining a desired rate of acoustic energy suitable to cause the accumulated acoustic energy to reach the maximum allowable threshold at the end of the desired period, and a step of controlling the gain based on that desired rate of acoustic energy, and based on the actual rate of acoustic energy. Another such additional feature is at least one of the steps of: updating the desired rate of acoustic energy during the desired period of listening, and updating the actual rate of acoustic energy during the desired period of listening.

Another such additional feature is the step of receiving a user input indicating a pause in the desired period of listening, and responding by at least one of: adapting the desired rate of acoustic energy to compensate for the pause, increasing the desired period to compensate for the pause, and continuing without compensating for the pause. Another such additional feature is the step of responding to the accumulated acoustic energy reaching the allowable threshold by at least one of: reducing the gain of the audio output to a safe level, ceasing control of the gain, and outputting an indication that the allowable threshold has been reached. Another such additional feature is the outputting step comprising at least one of causing a visual indication of predicted remaining listening time to be output on a visual display, causing an acoustic indication of the predicted remaining listening time to be output on the headset, causing output of an indication of the accumulated acoustic energy, causing output of an indication of what proportion of the desired listening time is remaining, and causing output of an indication of what proportion of the allowable threshold is the accumulated acoustic energy.

Another aspect provides a computer program stored on a non-transient computer readable medium and having instructions which when executed by a processor cause the processor to carry out any of the methods with any of the additional features as set out above.

Any of the additional features can be combined together and combined with any of the aspects. Other effects and consequences will be apparent to those skilled in the art, especially over compared to other prior art. Numerous variations and modifications can be made without departing from the claims of the present invention.

### BRIEF DESCRIPTION OF THE DRAWINGS

How the present invention may be put into effect will now be described by way of example with reference to the appended drawings, in which:

FIG. 1 shows a computing device having a monitoring part according to an embodiment,

FIG. 2 shows a monitoring part according to an embodiment with volume control,

FIG. 3 shows a monitoring part according to an embodiment with gain control,

FIGS. 4, 5 and 6 show embodiments having variants of the gain control mode of FIG. 3,

FIG. 7 shows an embodiment having various examples of outputs to the user,

FIG. 8 shows a flow chart for predicting remaining time according to an embodiment,

FIGS. 9 and 10 show flow charts for gain control mode according to embodiments,

FIG. 11 shows a functional flow chart view of two modes and user interface according to another embodiment,

FIG. 12 shows an embodiment with headset having the monitoring part, and

FIG. 13 shows an embodiment with a remote server having the monitoring part.

### DETAILED DESCRIPTION

The present invention will be described with respect to particular embodiments and with reference to certain drawings but the scope of the invention is not limited thereto. The drawings described are only schematic and are non-limiting.

In the drawings, the size of some of the elements may be exaggerated and not drawn to scale for illustrative purposes.

### Definitions:

Where the term “comprising” is used in the present description and claims, it does not exclude other elements or steps and should not be interpreted as being restricted to the means listed thereafter. Where an indefinite or definite article is used when referring to a singular noun e.g. “a” or “an”, “the”, this includes a plural of that noun unless something else is specifically stated.

References to software or programs can encompass any type of programs in any language executable directly or indirectly on processing hardware.

References to processors, hardware, processing hardware or circuitry can encompass any kind of logic or analog circuitry, integrated to any degree, and not limited to general purpose processors, digital signal processors, ASICs, FPGAs, discrete components or logic and so on. References to a processor are intended to encompass implementations using multiple processors which may be integrated together, or co-located in the same node or distributed at different locations for example.

References to energy or acoustic energy or accumulated acoustic energy can encompass for example acoustic exposure level over a period of time, acoustic dose or other commonly used terms, and can be referenced to values measured at ear drum (referred to as Drum Reference Point), or any preceding point along the audio signal path or acoustic path up to the ear drum such as

Ear Reference Point (ERP), with assumptions of the transfer functions further along those paths.

References to computing devices are intended to encompass any kind of computing device, not limited to mobile devices or personal computing devices or internet connected devices, and are intended to encompass systems using services provided by remote servers coupled over the internet.

References to headsets are intended to encompass any kind of headset for wearing and having speakers for outputting sound to a user.

References to user interfaces are intended to encompass any kind of user interface for enabling input or output from or to a user.

References to a processor being configured to determine something are intended to encompass any implementation of such functions, for example, but not limited to, modules of application specific integrated circuits or other firmware, or a general purpose processor or DSP with an associated memory storing a set of instructions for the general purpose processor or DSP to execute.

References to a maximum allowable threshold are intended to encompass any kind of threshold that maybe specified by law, legislation or Directive or specified recommendation from organizations or standard setting bodies, for example. Such thresholds can be a static or dynamic threshold, a single value, a multiple value threshold, or a multi-dimensional boundary defined as a function of variables such as listening time, country of use, headset sensitivity, ageing, location, external noise, time of day, identity of user, age of user, hearing sensitivity of user, type of music, history of listening by that user over previous weeks or years, predetermined margin below legal or healthy limit, user input margin below legal or healthy limit, and so on.

References to a monitoring part can encompass any kind of monitoring part for monitoring acoustic energy exposure including those having a gain control mode to limit the acoustic energy exposure.

### Abbreviations:

dB decibel

dBA A-weighted decibel

dBSPL Sound Pressure Level measured in dB

DSP Digital Signal Processor

FPGA Field Programmable Gate Array

PI Proportional Integral

PID Proportional Integral Derivative

TWA Time Weighted Average

### Introduction

By way of introduction to the embodiments, some issues with conventional designs will be explained. Conventional acoustic energy monitoring for headsets may not be sufficiently convenient or effective for a user, particularly if they want to listen at high volume close to a maximum threshold. This may arise for example because they are working in a noisy environment or they are listening to music and prefer to play it at a volume which is as high as possible without causing hearing damage. There is increasing awareness of potential hearing damage when listening to loud music through the headset; however, the advice and recommendations are often inadequate, contradictory and confusing. One recent newspaper article suggested one hour limit listening time, yet refers to 15 minutes at 100 dB to be unsafe. It further confuses the reader by referring to some devices producing up to 136 dB. The fact is exposure level is dependent on several factors such as duration of listening time, the volume levels on the mobile device and/or the headset and the transfer function (often called sensitivity) of the speakers used in the headset.

However conventional devices are aimed at keeping users away from the maximum threshold, and up to now it has not been understood that they are not suited or easy to use when the user want to operate as close as possible to the allowable threshold while remaining protected or safe. Embodiments as described below address these issues in various ways.

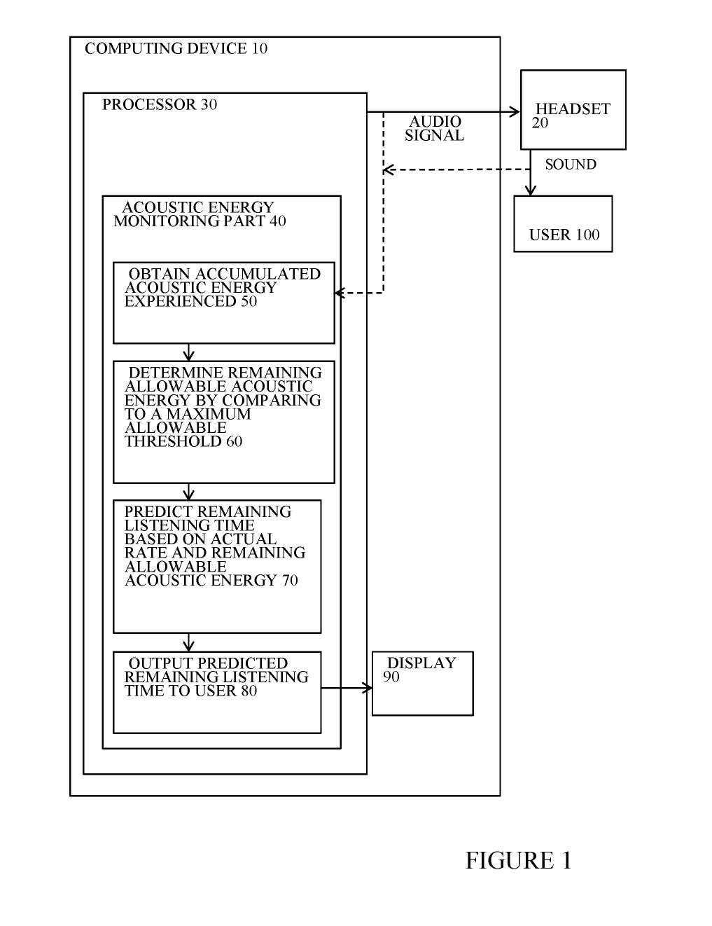

### FIG. 1, Computing Device Having Monitoring Part According to an Embodiment

FIG. 1 shows a schematic view of apparatus for monitoring acoustic energy experienced by a user of a headset, in the form of a computing device 10. This can be any kind of computing device, for example a desktop or mobile personal computer, a handheld or wearable device such as a notebook or mobile phone or smartphone, or a display device such as a TV or internet connected TV or home cinema. In some cases the device can serve multiple headset users in a workplace or cinema or silent disco type application. It is coupled a headset 20 providing sound to a user 100. The computing device has a processor 30 and a user interface (audio output to the headset), and/or display 90. The processor may be implemented using a DSP or any kind of conventional hardware, firmware and programs, so as to achieve a number of functions, depending on the type of computing device. In this view, only the most relevant functions are shown, for use in the passive display mode of operation, there may be many more not shown. The processor has a part or module configured for monitoring acoustic energy 40, and this has a number of functions which are shown in the form of steps or modules which can be implemented in software or any kind of hardware or firmware for carrying out logic operations. These functions can be incorporated together or divided in other ways than that shown. A first of these is configured to obtain an accumulated acoustic energy already experienced by the user after a start time as shown by part or step 50. This can be implemented in various conventional ways for example based on sound measurements from an in ear microphone, or based on audio signal values modified by a transfer function of the headset, a transfer function of the airspace between the headset and the ear and so on. Dotted lines in FIG. 1 show these possible alternative inputs from the sound output by the headset or from the audio signal for use in obtaining the accumulated acoustic energy.

A part or step 60 is provided for determining a remaining allowable acoustic energy by comparing the accumulated acoustic energy to a maximum allowable threshold. The maximum allowable threshold can be for example a single value or a set or matrix of values, and may follow regulatory requirements. For example it can be set to be 85 dBA for an 8 hour period, and 3 dBA greater for each halving of the period. As another example, with a different safety margin, if the user chooses to listen to 4 hours of music then their average daily dose allowance is limited to maximum 88 dBA, on the other-hand if the user chooses to listen to say 2 hour then the app allows volume increase up to 91 dBA. Limit to 1 hour allows 94 dBA and so on. This means a user can listen to music at higher volumes for shorter periods with the confidence that their hearing is not damaged.

A part or step 70 is provided to determine a predicted remaining listening time based on an actual rate of acoustic energy, and on the remaining allowable acoustic energy before the maximum threshold is reached. This can be calculated in various ways, and can be updated periodically as needed. A part or step 80 is also provided to cause the user interface to output an indication of the predicted remaining listening time to the user. Again there are numerous possible ways of implementing this and only some are described.

Compared to a conventional output indicating a projected energy exposure by the end of a preselected period, by calculating and outputting the predicted remaining listening time, the monitoring can be more useful, easier to understand and can help enable a listener to control their exposure without the inconvenience of needing prior user input of an expected period of listening time. Such ease of use makes it more likely that users will make more use of the monitoring, and thus better protect their hearing from damage. Also it can be combined easily with other hearing protection measures such as limiting the gain.

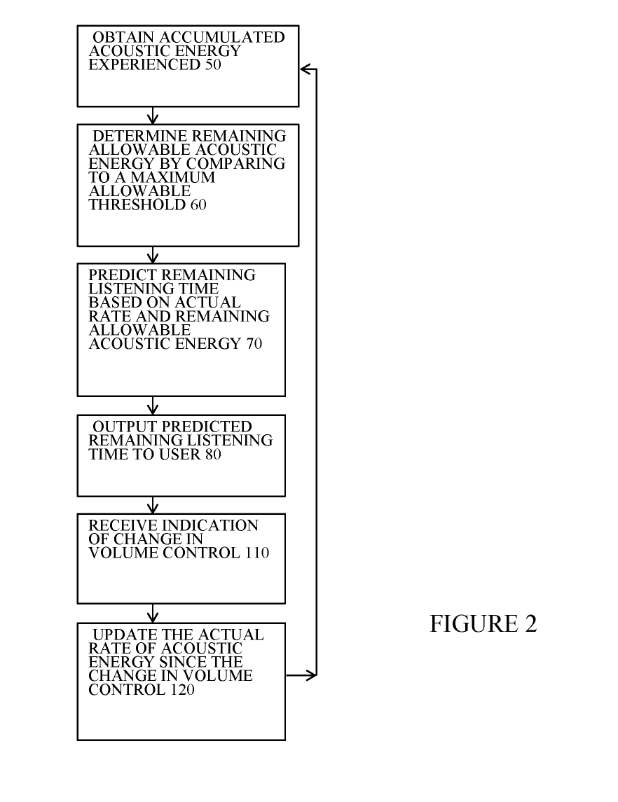

FIG. 2, Monitoring Part According to Embodiment with Volume Control

FIG. 2 shows steps or parts for monitoring according to another embodiment which may be carried out by or implemented as part of a processor of a computing device as shown in other figures or other arrangements. Steps or parts 50, 60, 70 and 80 are as described above for FIG. 1. Notable additional features relate to volume control by the user when operating in the passive display mode. A step or part 110 is provided for receiving an indication of a change in the volume control. This volume control may take place at any of various places along a path of the audio signal for example from generation and equalisation and conversion to analog and amplification to output to the headset and any processing in the headset before the signal drives the speakers of the headset. A step or part 120 is also provided for updating the calculation of the rate of the acoustic energy since the change in volume control. The updated rate is then used in a next prediction of the remaining listening time, by repeating steps 50 to 80.

This figure is an example of the feature of processor being configured to receive an indication of a change in volume control by the user, to update the actual rate of acoustic energy since the change in volume control, and to update the predicted remaining listening time according to the updated actual rate of acoustic energy. By such updating of the predicted remaining listening time with changes in volume control, the user can be taught or shown the effect of changing the volume and thus it becomes considerably easier for a user to set an appropriate volume for a desired listening period. Setting the volume is typically easier than setting a listening period, as many listening devices or smart phones have dedicated volume control buttons, thus avoiding a need to use a keypad or to read menu based options and make selections for example.

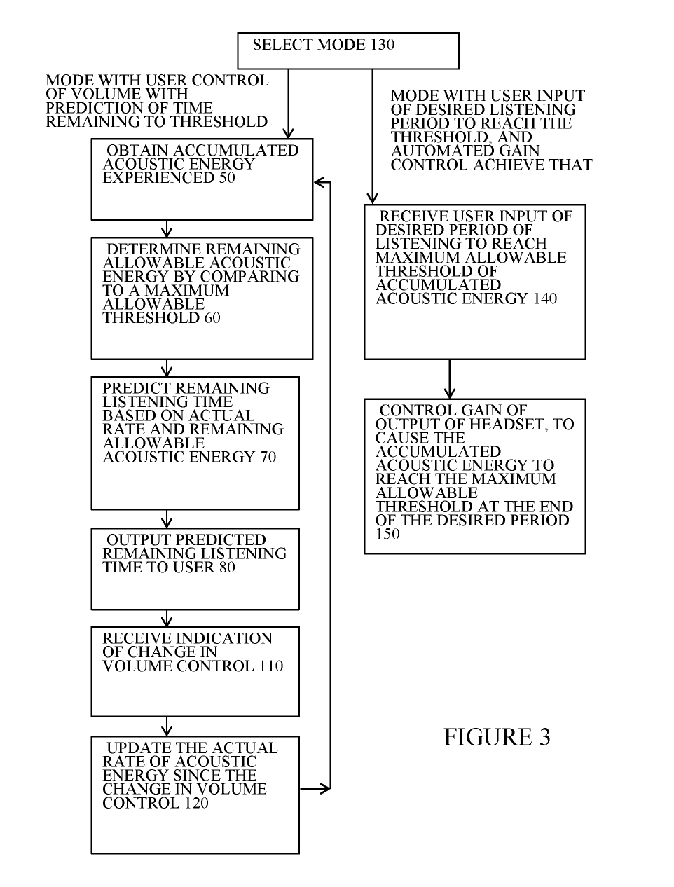

FIG. 3 Monitoring Part According to Embodiment with Gain Control

FIG. 3 shows steps or parts for monitoring according to another embodiment which may be carried out by or implemented as part of a processor of a computing device as shown in other figures or other arrangements. Steps or parts 50, 60, 70, 80, 110 and 120 are as described above for FIG. 2. Notable additional features relate to having an additional mode of operation, the gain control mode. As shown in FIG. 3 there is a step 130 of selecting between modes. A first of these modes has steps or uses parts as described above in relation to FIG. 2. This mode has user control of volume with a prediction of remaining listening time before the allowable threshold is reached. The other mode is a gain control mode in which there is user input of a desired listening period to reach the allowable threshold, with automated gain control to achieve that desire. This gain control mode has a part for, or step 140 of receiving user input of a desired period of listening to reach the maximum allowable threshold of accumulated acoustic energy, and a part for, or step 150 of controlling a gain of the output of the headset to cause the accumulated acoustic energy to reach that maximum allowable threshold at the end of the desired period. This gain control mode can help a user to maximise the volume within an allowable limit, such as a limit of safe listening without damage to a user's hearing. This automated gain control can operate to increase or decrease the gain, so as to be able to maximise the volume, not merely ensure compliance. So for the case that the volume at the start is low enough not to need limiting, the gain control can increase the gain to reach the allowable threshold. The automated gain control can in principle take place at any of various places along a path of the audio signal for example from generation and equalisation and conversion to analog and amplification to output to the headset and any processing in the headset before the signal drives the speakers of the headset.

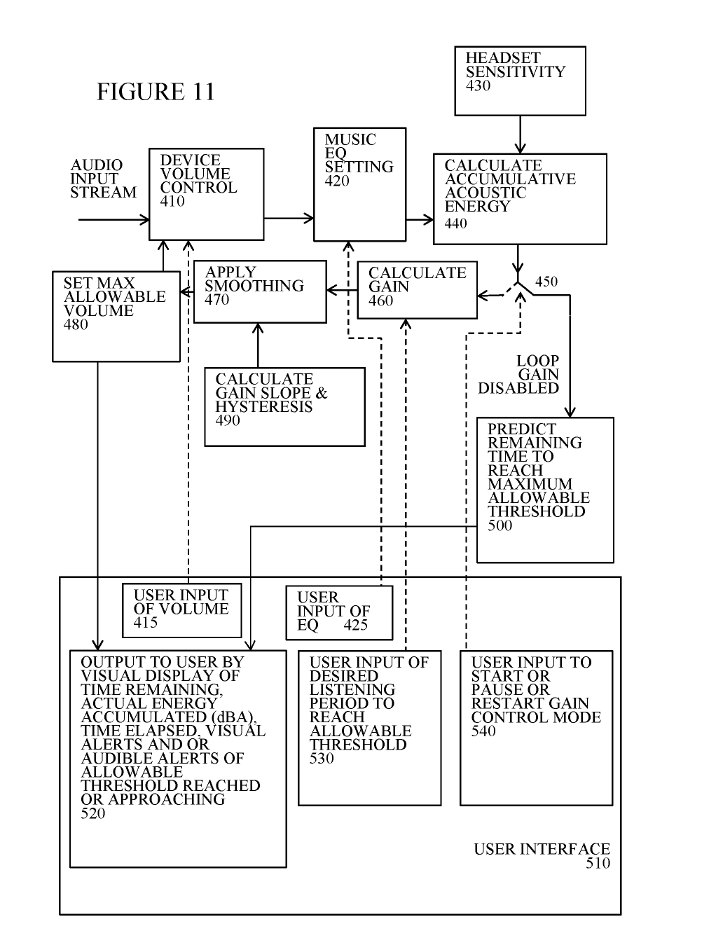

Typically, the user can also change the volume manually, while the gain control is active, but in this case the gain control would tend to undo such a manual volume change. There can be provided however a smoothing parameter as described below in relation to FIG. 11, that means it may take a short length of time to bring the volume back to the previous level. Note that in at least some embodiments the display of the remaining time can be always present, in both gain control and passive display modes.

In addition to the above scenario, there are two other possible scenarios under the gain control enabled mode: a) the volume control is completely ignored—i.e. volume is disabled during the gain control enabled mode; b) any event generated by the volume control (volume up or down) disables the gain control and hands the control back to the user, i.e., it reverts back to the first mode, that is a passive display mode. This can be thought of as operating similar to cruise-control in a car, whereby it is disabled if driver touches the brakes. Note that typically in either mode, gain control enabled or passive displayed, the display of the remaining time can be operational. Therefore, the user is always aware of the remaining time that he/she can safely continue listening in any mode.

In some embodiments these features can be implemented in an application (app) to run on mobile devices (phone, iPod, etc.) which offers hearing protection for anyone using their mobile device to listen to music via headset. A feature of this app is the user interface allows the user to select the duration of listening to music (e.g. 30 min, 1 hr, 2 hrs, etc.) and based on this time duration, the app automatically limits the maximum allowable volume level so that the maximum allowable threshold is reached over this period. This volume control ensures users' hearing safety in accordance to, for example, EU Directive 2003/10/EC and other hearing conservation standards, legislations and recommendations.

By allowing the user to set the period to listen to music up to the threshold, the app enables a respective increase in volume level without potential damage to hearing, more effectively, more safely and more conveniently than before. The gain control can therefore encompass increasing the gain if it is predicted not to reach the allowable threshold, as well as limiting the gain if it is predicted to exceed the allowable threshold. This means the gain control mode can ensure the threshold can be reached at the end of the desired time period not only for the case that the initial volume setting is too high, but also for the case that the initial volume setting is too low. Thus, by providing both up and down control of gain, the gain control goes beyond merely limiting to ensure compliance with the threshold, and ensures the volume is maximised, in the sense of being as high as safely possible within the threshold, even if this involves increasing the gain. The control of gain can be implemented using an algorithm such as a ‘P controller’, PI controller or PID controller which continuously calculates the acoustic energy delivered through the headset and adjusts the volume gain to ensure compliancy while maximising the volume over the given time period.

The user has the option of disabling this gain control hearing protection feature on the app in which case the controller will return to the first mode without gain control and hence be effectively ‘hands-off’. In this scenario or mode, the app will continue to calculate and display the amount of acoustic energy (hearing exposure) that the user is exposed to and to predict a listening time remaining.

The user can alter the volume control and the predicted remaining listening time will be updated, so the user can control this predicted remaining listening time to match their available time, so as to maximise their exposure to acoustic energy safely as desired. The app provides an output such as an audible indication and/or a visual alert to inform the user of the listening time remaining, and an alert if the maximum daily noise dose is approaching or is reached. If the user at any time then re-enables the gain control hearing protection feature, the controller first takes into account the amount of acoustic energy exposed thus far and then controls (and if required reduces) the volume level sufficiently to avoid reaching the specified daily accumulated acoustic energy allowance before the end of the given listening period. Thus the user can avoid potential hearing damage. It is then up to the user whether to maintain this gain control mode or again at any time disable the gain control mode and rely on manual volume control together with the indication of predicted remaining listening time.

Either of these features or the combination of modes can provide the user with control and convenience and knowledge of how close they are to those limits, to help them make most use of their allowable limits. As mentioned above, in the gain control enabled mode there are various possibilities for responding to changes in manual volume control: a) to bring the volume back to the previous level over a short period of time, using an appropriate smoothing parameter; b) the volume control is completely ignored during the gain control enabled mode; or c) pressing volume up or down disables the gain control and hands the control back to the user, i.e., it reverts back to passive display mode.

These are examples of the feature of the apparatus having a gain control mode in which the processor is configured to respond to a user input indicating a desired period of listening to reach the threshold, by controlling a gain of the output of the headset, to cause the accumulated acoustic energy to reach the maximum allowable threshold at the end of the desired period.

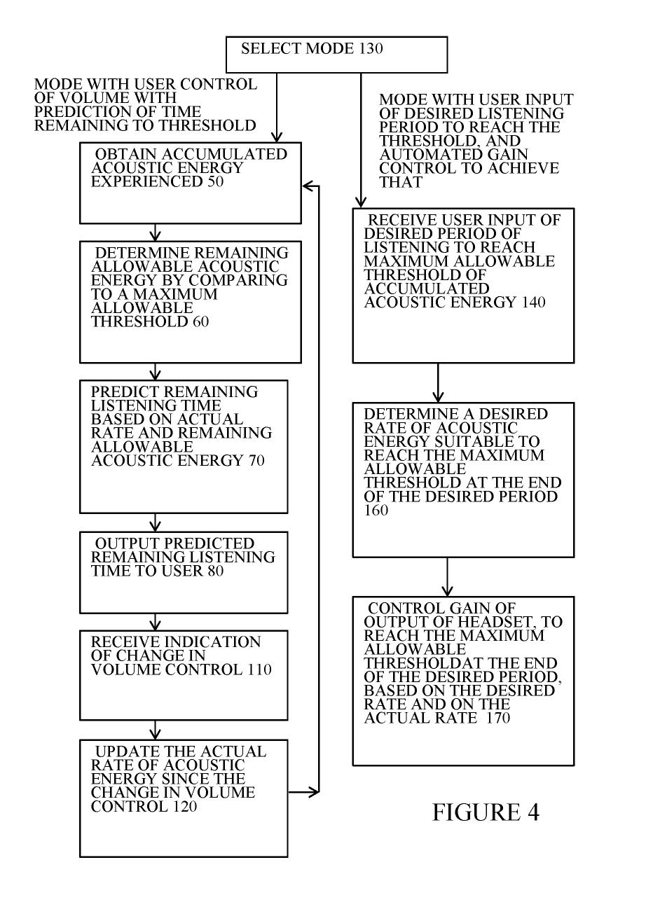

### FIGS. 4, 5, 6, Embodiments Having Variants of the Gain Control Mode

FIG. 4 shows steps or parts for monitoring according to another embodiment which may be carried out by or implemented as part of a processor of a computing device as shown in other figures or other arrangements. Steps or parts 50, 60, 70, 80, 110, 120, 130 and 140 are as described above for FIG. 3.

Notable additional features relate to the processor being configured to determine a desired rate of acoustic energy suitable to cause the accumulated acoustic energy to reach the maximum allowable threshold at the end of the desired period. A part for or step 160 is provided after step 140 for determining a desired rate of acoustic energy suitable to reach the maximum allowable threshold at the end of the desired period. This desired rate and the actual rate are then used at step 170 in the control of the gain to reach the maximum allowable threshold at the end of the desired period. Determining and using the desired rate is a convenient way to enable this control of the gain to help the user maximise the volume.

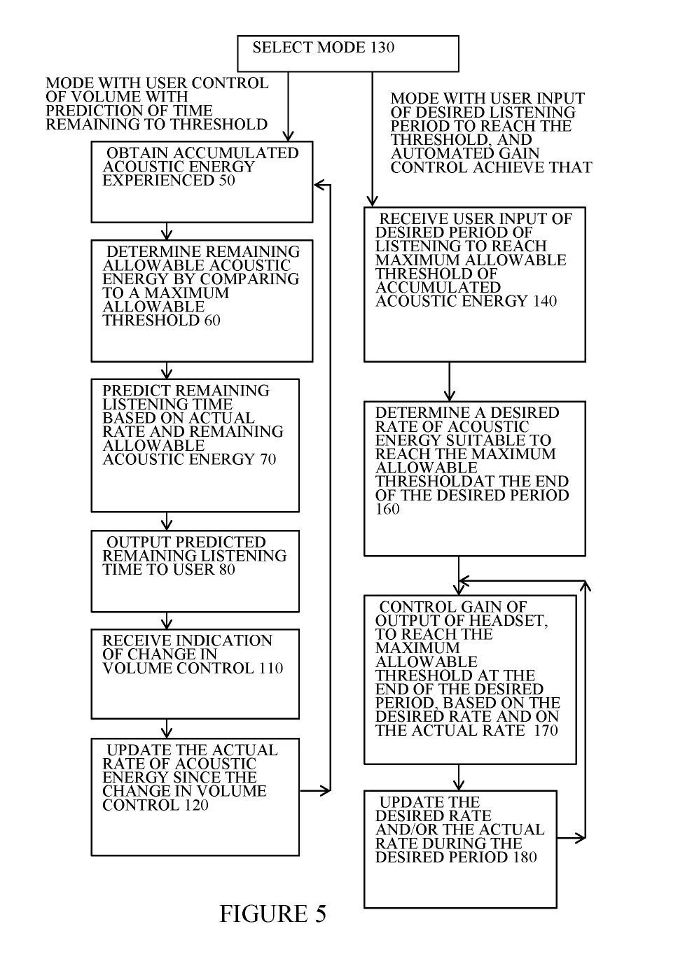

FIG. 5 shows steps or parts for monitoring according to another embodiment which may be carried out by or implemented as part of a processor of a computing device as shown in other figures or other arrangements. Steps or parts 50, 60, 70, 80, 110, 120, 130, 140, 160 and 170 are as described above for FIG. 4. Notable additional features relate to the processor being configured to update the desired rate of acoustic energy during the desired period. A part for or step 180 is provided after step 170 for updating the desired rate and/or updating the actual rate during the desired period. These updated values can then be fed back and used in a repeat of step 170 to control the gain to reach the maximum allowable threshold at the end of the desired period. This can improve an accuracy of the desired rate, and the actual rate, which can enable more accurate control of gain and thus enable better maximisation of rate particularly where the actual rate varies widely during the desired period.

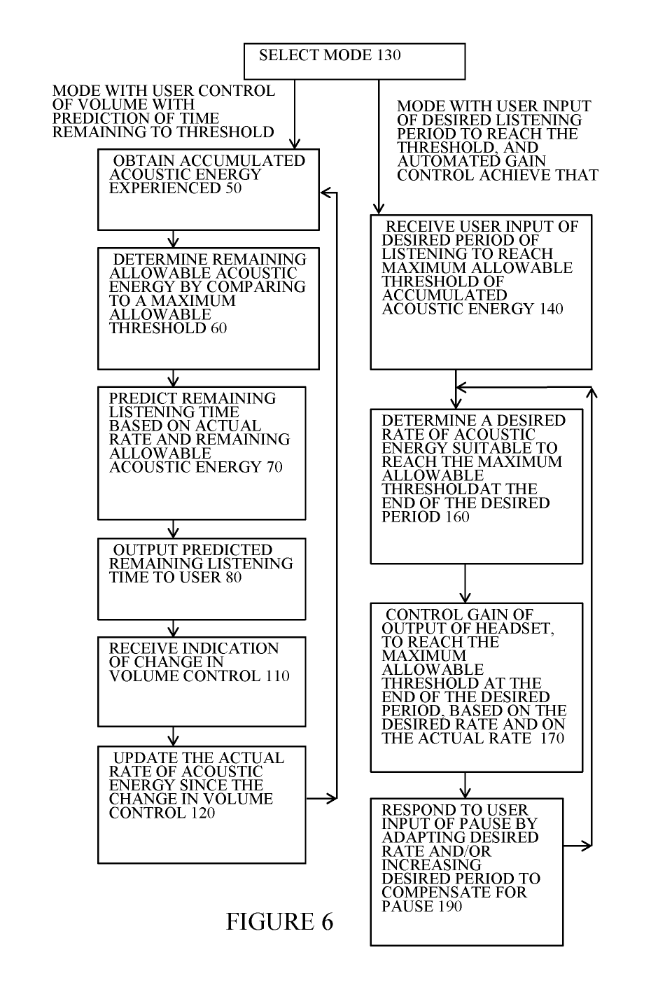

FIG. 6 shows steps or parts for monitoring according to another embodiment which may be carried out by or implemented as part of a processor of a computing device as shown in other figures or other arrangements. Steps or parts 50, 60, 70, 80, 110, 120, 130, 140, 160 and 170 are as described above for FIG. 4. Notable additional features relate to the processor being configured to receive a user input indicating a pause in the desired period of listening, and to respond by at least one of: adapting the desired rate of acoustic energy to compensate for the pause, and increasing the desired period to compensate for the pause. This is shown by a part for or a step 190 following on from step 170.

The new values of desired rate and/or desired period can be fed back and used in a repeat of steps 160 and 170 to control the gain to reach the maximum allowable threshold at the end of the desired period. This can be more convenient to a user and enable better maximisation of rate. This can help enable a user to maximise their usage of the exposure allowance conveniently and safely.

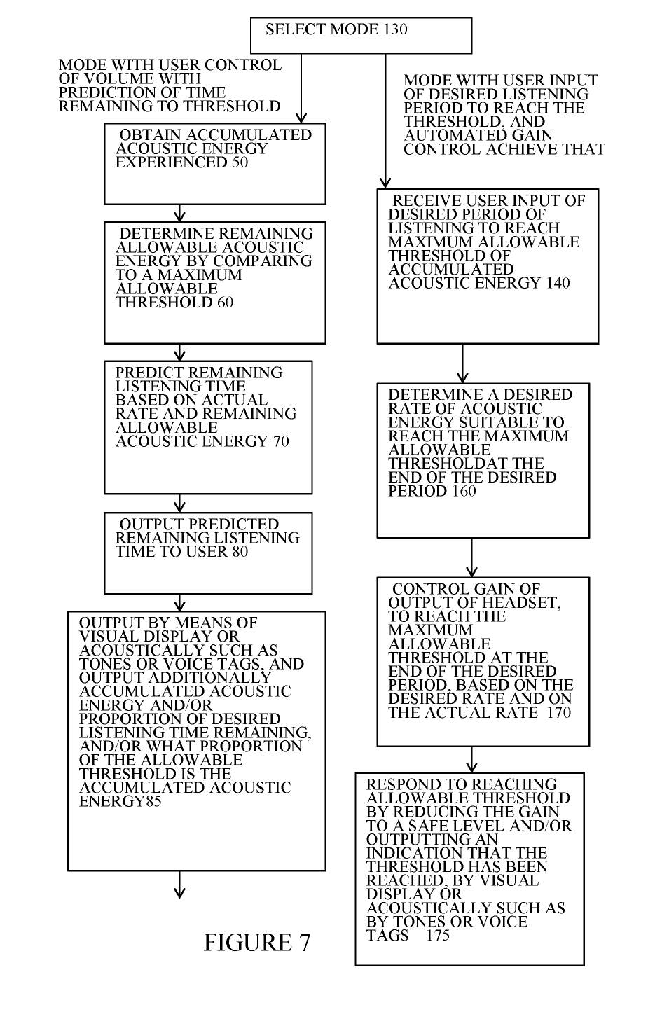

### FIG. 7, Embodiment Having Various Outputs to the User

FIG. 7 shows steps or parts for monitoring according to another embodiment which may be carried out by or implemented as part of a processor of a computing device as shown in other figures or other arrangements. Steps or parts 50, 60, 70, 80, 110, 120, 130, 140, 160 and 170 are as described above for FIG. 4. Notable additional features relate to the outputs. For the first mode, the output of the predicted remaining listening time as shown by part or step 85, following step 80, can be by means of visual display or acoustically, and can be supplemented by an indication of the accumulated acoustic energy, and/or an indication of what proportion of the desired listening time is remaining, and/or an indication of what proportion of the allowable threshold is the accumulated acoustic energy. These are various ways of providing more useful information to a user conveniently. This visual indication can be more convenient for a user, though other indications are possible such as speech or other audio or touch based indications. Many variations of visual indication are conceivable, such as graphs, numbers, symbols such as a bucket filling up and so on. The indication of accumulated acoustic energy can provide more information to a user and can help enable them to alter their listening or volume control, for example. The gain control mode can have similar outputs and supplementary outputs.

Also shown in this figure is another feature for the gain control mode, which may be implemented with or without the above mentioned output features. This is the part for or step 175 of responding to reaching the allowable threshold by reducing the gain of the audio output to a safe level, or ceasing control of the gain, and/or outputting an indication that the allowable threshold has been reached. This output can be by visual display and/or acoustically such as by tones or voice tags. These various steps can also help to enable the user to keep within the safe range. The outputting step for either of the modes can involve causing an acoustic indication of the predicted remaining listening time to be output on the headset, causing output of an indication of the accumulated acoustic energy, causing output of an indication of what proportion of the desired listening time is remaining, and causing output of an indication of what proportion of the allowable threshold is the accumulated acoustic energy.

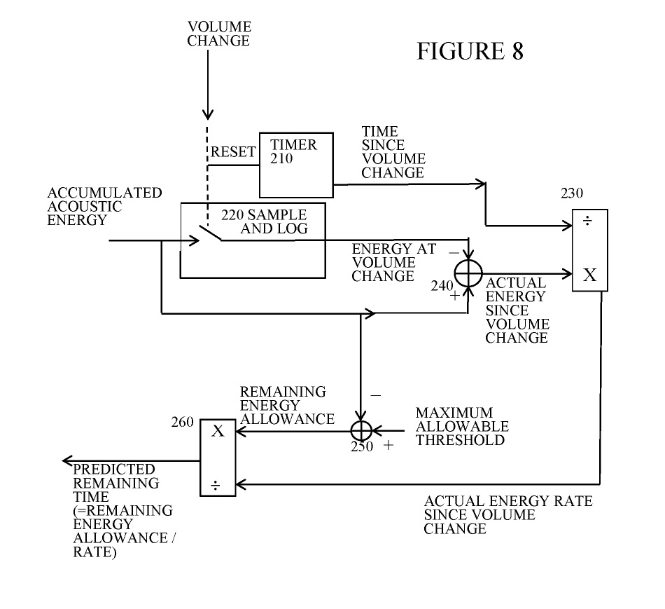

FIG. 8, Flow Chart for Predicting Remaining Time According to an Embodiment

FIG. 8 shows a functional flow chart for predicting the listening time remaining for use in the monitoring part of any of the embodiments described above or in other embodiments. The accumulated acoustic energy experienced so far is determined in any conventional way and input to a sample and log function 220.

This is arranged to take and store a sample of the accumulated acoustic energy triggered by a volume change or by a start signal of any kind (not shown). This provides an output indicating the energy at the last volume change. This is subtracted by a subtractor 240 from the accumulated acoustic energy signal to provide the actual energy experienced since the last volume change. To obtain the energy rate since the last volume change, the actual energy since the last volume change is divided by the time since the last volume change using divider 230. This time is counted by a timer 210, reset by a signal indicating the last volume change. A subtractor 250 is used to determine a remaining energy allowance by subtracting the accumulated acoustic energy from a maximum allowable threshold. A divider 260 is provided to divide the remaining energy allowance by the actual energy rate since the last volume change to calculate the remaining time. If the values are represented in decibels then as this is a logarithmic scale then the dividers can be implemented as subtractors.

In other words, as can be seen in FIG. 8, at any instance of manual volume change, a snapshot is effectively taken of the accumulative acoustic exposure level thus far. There is a reset of the timer after volume change to calculate the ‘Energy rate’ that is being exposed to hearing. Then the remaining allowable energy (Maximum allowable daily dose minus the energy consumed thus far) is obtained. Then the calculated remaining energy is divided by ‘Energy rate’ to determine the remaining listening time to reach the maximum allowable threshold or dose. The time can be displayed in standard digital / analogue form. It can also be displayed by a variety of graphical presentations such as a bucket filling up towards an indicated maximum level and the colour of the content can gradually change from initially green, then yellow and orange as it approaches the maximum daily does, and red when maximum is reached.

When the maximum allowable threshold is reached a number of alerts may be implemented, such as the red bucket flashing on the screen, and/or a mobile device vibration and/or a voice announcing the alert through the headset using a pre-recorded voice tag such as: ‘Maximum daily limit reached’ or ‘potential hearing damage’ or ‘reduce the volume to avoid potential hearing damage’, etc. . . .

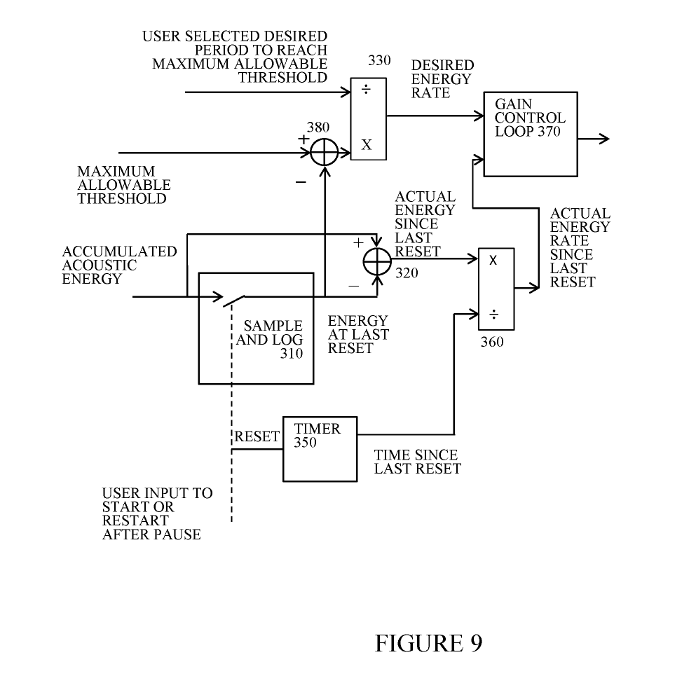

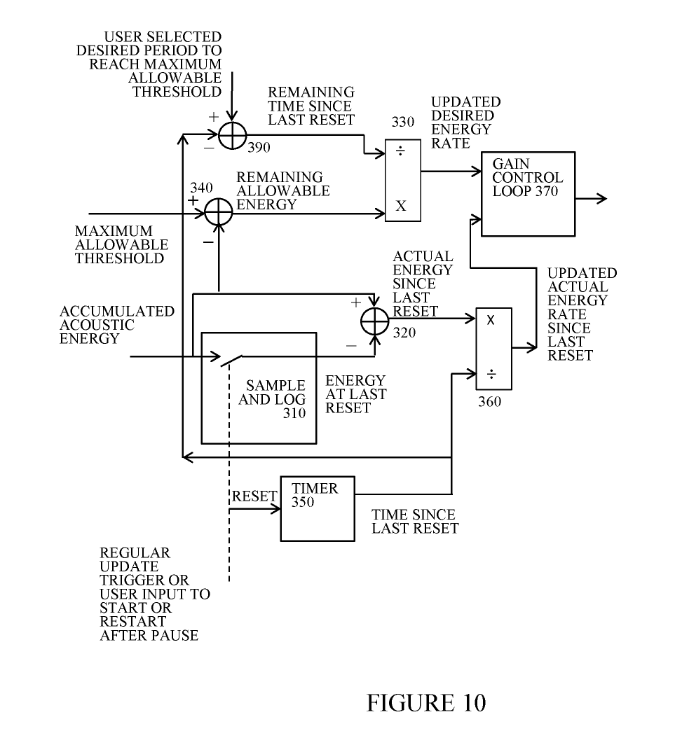

### FIGS. 9 and 10, Flow Charts for Gain Control Mode According to an Embodiment

FIG. 9 shows a functional flow chart for gain control for use in the monitoring part of any of the embodiments described above or in other embodiments. The accumulated acoustic energy experienced so far is determined in any conventional way and input to a sample and log function 310. This is arranged to take and store a snapshot of the accumulated acoustic energy thus far and is triggered by a start or restart signal of any kind. This sample and log function provides an output indicating the energy at the last reset. This is subtracted by a subtractor 320 from the accumulated acoustic energy signal to provide the actual energy experienced since the last reset. To obtain the energy rate since the reset, the actual energy since the last reset is divided by the time since the last reset using divider 360. This time is counted by a timer 350, reset by the same reset signal used to trigger the sample and log. A gain control loop 370 is provided to determine the gain based on minimising the difference between the actual energy rate since the last reset and the desired energy rate. This desired energy rate is determined by a divider 330 arranged to divide the remaining allowable energy (calculated by a subtractor 380 arranged to subtract the energy at last reset from the maximum allowable threshold) by a user selected desired period to reach the maximum allowable threshold. As before, if energy values are represented in decibels then as this is a logarithmic scale then the dividers can be implemented as subtractors.

FIG. 10 shows a functional flow chart similar to that of FIG. 9 but with the addition of more frequent updating of the two crucial inputs to the gain control loop 370 during the desired period. The desired energy rate is updated by providing a subtractor 340 to subtract the accumulated acoustic energy thus far from the maximum allowable threshold to derive a remaining allowable energy.

This can be updated regularly, for example every minute or every five minutes.

Also the remaining part of the desired time since the last reset needs to be derived, shown by subtractor 390 for subtracting the time since the last reset from the user selected desired period. This can also be updated regularly, for example every minute or every five minutes. This remaining time since last update is fed to the divider 330, to divide the remaining allowable energy, to derive the updated desired energy rate. The actual energy rate can be updated more frequently simply by providing the periodic update signals. In principle the actual energy rate could be updated at a different rate to the updating of the desired energy rate. This could be implemented for example by providing a separate sample and log function and separate timer for the updated actual energy rate calculation, if desired.

In other words as shown in FIG. 10, the remaining allowable maximum threshold=Max allowable threshold minus the accumulated acoustic energy (which is the continuously updated exposure dose used up to the moment the update is triggered). This gives the remaining allowable acoustic energy to be used within the specified time. The remaining allowable energy/time=desired rate (which is the maximum allowable energy rate). The ‘Actual energy rate’ is compared with this maximum allowable energy rate to control the gain. To calculate the ‘Actual energy rate’, a snapshot of the accumulative acoustic level at the last reset is used. The timer is also reset at this instant. Calculation of the actual energy rate can take place every minute for example. This can improve the accuracy of the desired rate, which can enable more accurate control of gain and thus enable better maximisation of rate particularly where the actual rate varies widely during the desired period.

### FIG. 11, Functional View of Two Modes and User Interface According to Another Embodiment

FIG. 11 shows a schematic view of operation of an embodiment with two modes as described above. A user interface 510 with inputs and outputs is shown at the bottom of the view. An audio input stream is generated or received, passed through a device volume control function 410, fed by a volume level input 415 from a user as shown by a dotted line. The audio input stream is then passed to a music EQ setting function 420 (fed by an EQ input 425 from the user as shown by a dotted line) and may be output to the headset (not shown). These functions may be carried out on an analog signal or a digital signal using conventional techniques. From this signal an accumulated acoustic energy is determined at part 440, with input from a store 430 of the transfer function of the headset (headset sensitivity). This accumulated acoustic energy value can pass along two paths according to which mode is selected at part 450, according to user input. This user selection input is shown by dotted line from part 540 of the user interface, which receives user input to start or to pause or to restart the gain control mode. For a first mode in which loop gain is not controlled, there is a part 500 for predicting the remaining listening time to reach the maximum allowable threshold based on the calculated accumulated acoustic energy. This feeds a part 520 of the user interface, for outputting to the user, by visual display or other means. The output can include accumulated acoustic energy, and other alerts as the threshold approaches or is reached. In some cases this prediction of remaining time can also be carried out and output while the gain control mode is being used, as will be described below.

When the gain control mode is selected, a gain control part 460 receives the accumulated acoustic energy and receives user input from part 530 of the user interface specifying a desired listening period to reach the allowable threshold, it calculates the gain to achieve this. The gain value is smoothed by part 470, using values for gain slope and hysteresis provided by part 490. The resulting volume control setting is carried out by part 480 which controls the volume control part 410 to apply it to the audio input stream. As mentioned above, in the gain control enabled mode there are various possibilities for responding to changes in manual volume control by the user: a) making a gradual change in gain over a period of time to compensate for the volume control input, for example by bringing the volume back to the previous level over a short period of time, using an appropriate smoothing parameter; b) maintaining the same gain control mode without compensating, so the volume control is completely ignored during the gain control enabled mode; or c) ceasing the gain control mode which can mean that pressing volume up or down disables the gain control and hands the control back to the user, i.e., it reverts back to passive display mode. The gain control mode can be described as a music limiter, which, when enabled, means the volume is controlled to achieve a maximum allowable level for the music time interval selected by the user.

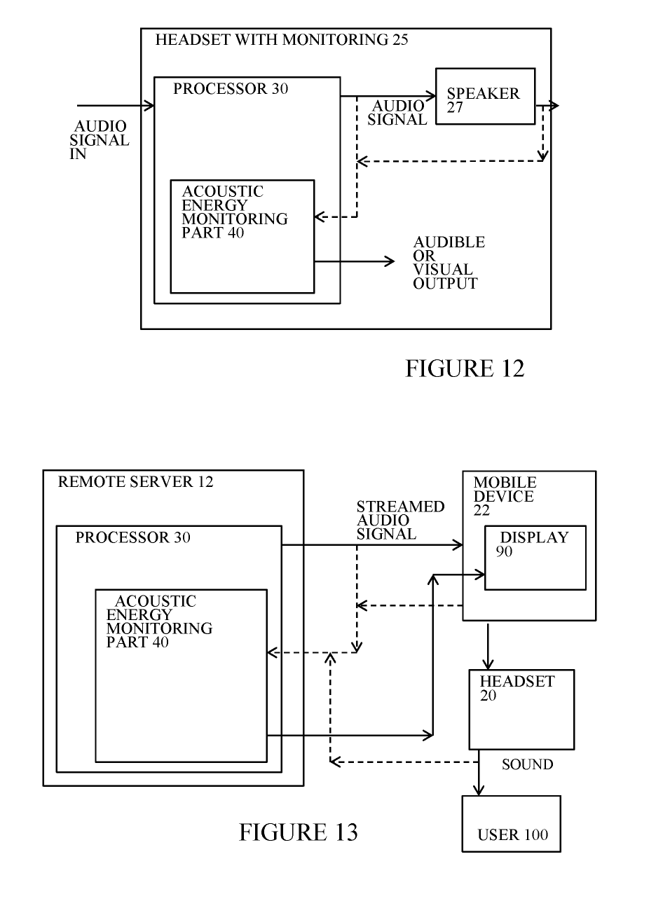

FIG. 12, Embodiment with Headset Having Monitoring Part

FIG. 12 shows a schematic view of a headset 25 incorporating a processor having the acoustic monitoring part 40. This acoustic energy monitoring part can be implemented according to any of the figures described above, to include any of the features or ways of implementing the gain control mode described above for example, or in other ways. There is a path for an audio signal in to the processor of the headset and a path for an audio signal from the processor to a speaker 27 of the headset. As shown by dotted lines, the acoustic energy monitoring part can be fed with a signal from the output of the speaker using a conventional microphone, and/or be fed with the audio signal from the input to the speaker (typically including taking into account the sensitivity of the speaker mounted in the headset), to enable the accumulated acoustic energy to be derived and used as described above. The acoustic energy monitoring part may provide output to a user interface in the form of entirely acoustic indications such as tones and voice tags, or by means of a small display on the headset, or by using a conventional wireless or wired connection to some other device such as a smartphone or personal computer or interconnected television or other display device, to cause it to display an indication of predicted listening time, approaches to maximum exposure, maximum exposure reached or other indications as described above.

### FIG. 13, Embodiment Having Remote Server Having Monitoring Part

FIG. 13 shows a schematic view of a system including a remote server 12 which incorporates a processor 30 having the acoustic monitoring part 40. This acoustic energy monitoring part can be implemented according to any of the figures described above, or in other ways, so it can include any of the features or ways of implementing the gain control as described above. In this case there is a path for the audio signal from the processor 30 of the remote server, to provide a streamed audio signal to a mobile device 22, for example via conventional internet protocols. The mobile device, such as a laptop or smart phone converts the streamed audio signal into an audio signal such as an analog signal suitable for the headset 20, for outputting sound to the user 100.

The streamed audio signal can of course be associated with a video signal for output on a display 90 on the mobile device. The acoustic energy monitoring part is provided with the audio signal fed back from any one or more parts of the audio signal path as shown by dotted lines from the streamed audio signal, from the mobile device or from the sound output of the headset (and typically taking into account the sensitivity of the speaker mounted in the headset). Thus it can derive the accumulated acoustic energy and operate as set out above in relation to FIGS. 1 to 11 for example. An output of the acoustic energy monitoring part at the remote server can be fed to a user interface in the form of the display 90 of the mobile device, or be output acoustically to the user by adding tones or voice tags at any point into the audio path for example.

### Other Remarks

As has been described above, for monitoring acoustic energy experienced by a user of a headset 20, 25, a processor 30 and a user interface 90 are provided, the processor having a monitoring part 40 to obtain an accumulated acoustic energy already experienced, to determine 60 a remaining allowable acoustic energy up to a maximum allowable threshold. A predicted remaining listening time is determined 70 based on an actual rate of acoustic energy, and on the remaining allowable acoustic energy, and is output visually or acoustically using the user interface. This helps enable the user to control their exposure with or without prior user input of an expected period of listening time. It can be updated after a change in volume control by the user. A gain control mode involves controlling the gain to cause the accumulated acoustic energy to reach the maximum allowable threshold at the end of a user defined period.

Another aspect provides an apparatus for monitoring acoustic energy experienced by a user of a headset, the apparatus having a processor and a user interface, the processor being configured to obtain an accumulated acoustic energy already experienced by the user after a start time, receive a user input indicating a desired period of listening to reach a maximum allowable threshold of accumulated acoustic energy, and control a gain to cause the accumulated acoustic energy to reach a maximum allowable threshold at the end of the desired period, without necessarily predicting the remaining listening time. This can be combined with features of other embodiments, such as the features described above, particularly those in relation to FIGS. 3 to 13 for example. Another aspect of the invention provides apparatus for monitoring acoustic energy experienced by a user of a headset, the apparatus having a processor and a user interface, the processor being configured to: obtain an accumulated acoustic energy already experienced by the user after a start time, and determine a remaining allowable acoustic energy by comparing the accumulated acoustic energy to a maximum allowable threshold. It is also configured to determine a predicted remaining listening time based on an actual rate of acoustic energy, and on the remaining allowable acoustic energy, and to cause the user interface to output an indication of the predicted remaining listening time to the user. This aspect can be combined with features of other embodiments, such as the features described above, particularly those in relation to FIGS. 2 to 13 for example.

Other variations can be envisaged within the scope the claims.

1. Apparatus for monitoring acoustic energy experienced by a user of a headset, the apparatus having a processor and a user interface, the processor being configured to operate in a gain control mode to:
obtain an accumulated acoustic energy already experienced by the user after a start time,
receive a user input indicating a desired period of listening to reach a maximum allowable threshold of accumulated acoustic energy, and
control a gain to increase a volume level of the headset to cause the accumulated acoustic energy to reach a maximum allowable threshold at the end of the desired period.

2. The apparatus of claim 1, the processor also being configured to operate in a passive display mode to:
obtain an accumulated acoustic energy already experienced by the user after a start time,
determine a remaining allowable acoustic energy by comparing the accumulated acoustic energy to a maximum allowable threshold,
determine a predicted remaining listening time based on an actual rate of acoustic energy, and on the remaining allowable acoustic energy, and
cause the user interface to output an indication of the predicted remaining listening time to the user.

3. The apparatus of claim 2, the processor being configured to receive an indication of a change in volume control by the user, to update the actual rate of acoustic energy since the change in volume control, and to update the predicted remaining listening time according to the updated actual rate of acoustic energy.

4. The apparatus of claim 1, the processor being configured to determine a desired rate of acoustic energy suitable to cause the accumulated acoustic energy to reach the maximum allowable threshold at the end of the desired period, and to control the gain based on that desired rate of acoustic energy, and based on the actual rate of acoustic energy.

5. The apparatus of claim 4, the processor being configured to update, during the desired period, at least one of: the desired rate of acoustic energy and the actual rate of acoustic energy.

6. The apparatus of claim 1, the processor being configured to respond to a volume control input by the user by at least one of: making a gradual change in gain over a period of time to compensate for the volume control input, maintaining the same gain control mode without compensating, and ceasing the gain control mode.

7. The apparatus of claim 1, the processor being configured to receive a user input indicating a pause in the desired period of listening, and to respond by at least one of: adapting the desired rate of acoustic energy to compensate for the pause, and increasing the desired period to compensate for the pause.

8. The apparatus of claim 2, the user interface having a display and the indication of predicted remaining listening time comprising at least one of: a visual indication on the display of the predicted remaining listening time, an acoustic indication of the predicted remaining listening time, an indication of the accumulated acoustic energy, an indication of what proportion of the desired listening time is remaining, and an indication of what proportion of the allowable threshold is the accumulated acoustic energy.

9. A headset comprising apparatus for monitoring acoustic energy experienced by a user of a headset, the apparatus having a processor and a user interface, the processor being configured to operate in a gain control mode to:
obtain an accumulated acoustic energy already experienced by the user after a start time,
receive a user input indicating a desired period of listening to reach a maximum allowable threshold of accumulated acoustic energy, and
control a gain to increase a volume level of the headset to cause the accumulated acoustic energy to reach a maximum allowable threshold at the end of the desired period.

10. A computing device comprising apparatus for monitoring acoustic energy experienced by a user of a headset, having an audio circuit for generating an audio signal for the headset, and a display for the output to the user, the apparatus also having a processor and a user interface, the processor being configured to operate in a gain control mode to:
obtain an accumulated acoustic energy already experienced by the user after a start time,
receive a user input indicating a desired period of listening to reach a maximum allowable threshold of accumulated acoustic energy, and
control a gain to increase a volume level of the headset to cause the accumulated acoustic energy to reach a maximum allowable threshold at the end of the desired period.

11. A method of monitoring acoustic energy experienced by a user of an acoustic headset, having, in a gain control mode of operation, steps of:
obtaining an accumulated acoustic energy already experienced by the user after a start time,
receiving a user input indicating a desired period of listening to reach a maximum allowable threshold of accumulated acoustic energy, and
controlling a gain to increase a volume level of the headset to cause the accumulated acoustic energy to reach a maximum allowable threshold at the end of the desired period.

12. The method of claim 11, and having, in a passive display mode of operation, steps of:
obtaining an accumulated acoustic energy already experienced by the user after a start time,
determining a remaining allowable acoustic energy by comparing the accumulated acoustic energy to a maximum allowable threshold,
determining a predicted remaining listening time based on an actual rate of acoustic energy, and on the remaining allowable acoustic energy, and
outputting to the user an indication of the predicted remaining listening time.

13. The method of claim 12, and having steps of receiving an indication of a change in volume control of the headset by the user, updating the actual rate of acoustic energy since the change in volume control, and updating the predicted remaining listening time according to the updated actual rate of acoustic energy.

14. The method of claim 11, having a step of determining a desired rate of acoustic energy suitable to cause the accumulated acoustic energy to reach the maximum allowable threshold at the end of the desired period, and controlling the gain based on that desired rate of acoustic energy, and based on the actual rate of acoustic energy.

15. The method of claim 14, having at least one of the steps of:
updating the desired rate of acoustic energy during the desired period of listening, and updating the actual rate of acoustic energy during the desired period of listening.

16. The method of claim 11, having the step of receiving a user input indicating a pause in the desired period of listening, and responding by at least one of: adapting the desired rate of acoustic energy to compensate for the pause, increasing the desired period to compensate for the pause, and continuing without compensating for the pause.

17. The method of claim 11, having the step of responding to the accumulated acoustic energy reaching the allowable threshold by at least one of: reducing the gain of the audio output to a safe level, ceasing control of the gain, and outputting an indication that the allowable threshold has been reached.

18. The method of claim 12, the outputting step comprising at least one of causing a visual indication of predicted remaining listening time to be output on a visual display, causing an acoustic indication of the predicted remaining listening time to be output on the headset, causing output of an indication of the accumulated acoustic energy, causing output of an indication of what proportion of the desired listening time is remaining, and causing output of an indication of what proportion of the allowable threshold is the accumulated acoustic energy.

19. A computer program stored on a non-transient computer readable medium and having instructions which when executed by a processor cause the processor to carry out a method of monitoring acoustic energy experienced by a user of an acoustic headset, having, in a gain control mode of operation, steps of:
responding to a user input indicating a desired period of listening with a maximised rate of accumulation, by controlling the gain to cause the accumulated acoustic energy to reach the maximum allowable threshold at the end of the desired period.
